(19) United States
(12) Patent Application Publication
(10) Pub. No.: US 2026/0214520 A1
(43) Pub. Date: Jul. 23, 2026

(54) METHOD AND APPARATUS FOR COMMUNICATING IN IAB NETWORK

(71) Applicant: LENOVO (BEIJING) LIMITED, Beijing (CN)

(72) Inventors: Yibin ZHUO, Shanghai (CN); Mingzeng DAI, Shanghai (CN); Lianhai WU, Beijing (CN); Le YAN, Shanghai (CN)

(21) Appl. No.: 19/134,524

(22) PCT Filed: Feb. 16, 2023
(86) PCT No.: PCT/CN2023/076474

§ 371 Date: May 30, 2025

(51) Int. Cl. H04W 36/00

(52) U.S. Cl. CPC H04W 36/0072; H04W 36/0058

(57) ABSTRACT

Embodiments of the present disclosure relate to a method and apparatus for communicating in an integrated access and backhaul (IAB) network. According to some embodiments of the disclosure, a base station (BS) may: configure a cell(s) of a first wireless network node whether to support an access from or a handover of a mobile wireless network node or not; and perform an integration procedure with a first mobile wireless network node via the first wireless network node, wherein at least one cell of the first wireless network node is configured to support an access from or a handover of a mobile wireless network node and the first wireless network node is a parent node of the first mobile wireless network node after the integration procedure.

### TECHNICAL FIELD

Embodiments of the present disclosure generally relate to communication technology, and more particularly to communicating in an integrated access and backhaul (IAB) network.

### BACKGROUND

Wireless communication systems are widely deployed to provide various telecommunication services, such as telephony, video, data, messaging, broadcasts, and so on. Wireless communication systems may employ multiple access technologies capable of supporting communication with multiple users by sharing available system resources (e.g., time, frequency, and power). Examples of wireless communication systems may include fourth generation (4G) systems, such as long term evolution (LTE) systems, LTE-advanced (LTE-A) systems, or LTE-A Pro systems, and fifth generation (5G) systems which may also be referred to as new radio (NR) systems.

To extend the coverage and availability of wireless communication systems (e.g., 5G systems), the 3rd generation partnership project (3GPP) is envisioning integrated access and backhaul (IAB) architecture for supporting multi-hop relays. In an IAB network, an IAB node may hop through one or more IAB nodes before reaching a base station (also referred to as “an IAB donor” or “a donor node”). A single hop may be considered a special instance of multiple hops. Multi-hop backhauling is beneficial because it provides a relatively greater coverage extension compared to single-hop backhauling. In a relatively high frequency radio communication system (e.g., radio signals transmitted in frequency bands over 6 GHz), relatively narrow or less signal coverage may benefit from multi-hop backhauling techniques.

The industry desires technologies for facilitating communications in the IAB

### SUMMARY

Some embodiments of the present disclosure provide a first base station (BS). The first BS may include a transceiver; and a processor coupled to the transceiver. The processor may be configured to: configure a cell(s) of a first wireless network node whether to support an access from or a handover of a mobile wireless network node or not; and perform an integration procedure with a first mobile wireless network node via the first wireless network node, wherein at least one cell of the first wireless network node is configured to support an access from or a handover of a mobile wireless network node and the first wireless network node is a parent node of the first mobile wireless network node after the integration procedure.

In some embodiments of the present disclosure, the transceiver is configured to receive, from a second BS, a first uplink (UL) backhaul adaptation protocol (BAP) configuration associated with a second distributed unit (DU) of a third wireless network node, wherein the third wireless network node includes a first DU having an F1 connection to the first BS and the second DU having an F1 connection to the second BS.

In some embodiments of the present disclosure, the first UL BAP configuration is based on UL traffic information transmitted from the first BS to the second BS.

In some embodiments of the present disclosure, the transceiver is configured to transmit a handover request to a second BS to hand over at least one UE served by the first mobile wireless network node. For each of the at least one UE, the handover request indicates at least one of: whether a corresponding UE is on board of a vehicle mounted by the first mobile wireless network node or surrounds the vehicle mounted by the first mobile wireless network node; or a handover priority level for the corresponding UE, wherein the handover request is to hand over all connected UEs served by the first mobile wireless network node.

In some embodiments of the present disclosure, the transceiver is configured to receive, from the second BS, a response to the handover request. The response includes at least one of: a list of admitted UEs among the at least one UE based on the handover priority level; or a list of refused UEs among the at least one UE based on the handover priority level.

Some embodiments of the present disclosure provide a second BS. The second BS may include a processor; and a transceiver coupled to the processor. The transceiver may be configured to: receive, from a first BS, a first handover request to hand over at least one user equipment (UE) served by a first mobile wireless network node, wherein for each of the at least one UE, the first handover request indicates at least one of: whether a corresponding UE is on board of a vehicle mounted by the first mobile wireless network node or surrounds the vehicle mounted by the first mobile wireless network node; or a handover priority level for the corresponding UE, wherein the first handover request is to hand over all connected UEs served by the first mobile wireless network node; and transmit, to the first BS, a first response to the first handover request.

In some embodiments of the present disclosure, the first response includes at least one of: a list of admitted UEs among the at least one UE based on the handover priority level; or a list of refused UEs among the at least one UE based on the handover priority level.

In some embodiments of the present disclosure, the transceiver is further configured to perform at least one of the following: receiving, from the first BS, first information about whether a cell(s) of a first wireless network node supports an access from or a handover of a mobile wireless network node or not, wherein the first wireless network node connects to the first BS; receiving, from the first BS, second information about whether a cell(s) of a distributed unit (DU) of the first BS supports an access from or a handover of a mobile wireless network node or not; transmitting, to the first BS, third information about whether a cell(s) of a second wireless network node supports an access from or a handover of a mobile wireless network node or not, wherein the second wireless network node connects to the second BS; or transmitting, to the first BS, fourth information about whether a cell(s) of a DU of the second BS supports an access from or a handover of a mobile wireless network node or not.

In some embodiments of the present disclosure, the transceiver is further configured to: receive, from the first BS, a second handover request to hand over the first mobile wireless network node; and transmit, to the first BS, a second response to the second handover request, wherein the second response indicates a handover preparation failure due to a target cell of the second handover request not supporting a handover of a mobile wireless network node.

In some embodiments of the present disclosure, the transceiver is further configured to perform at least one of the following: receiving, from the first BS, first information about whether a cell(s) of the first BS is a cell of a mobile wireless network node or not; or transmitting, to the first BS, second information about whether a cell(s) of the second BS is a cell of a mobile wireless network node or not.

In some embodiments of the present disclosure, the transceiver is further configured to: receive, from the first BS, a second handover request to hand over a wireless network node from the first BS to a cell of the second BS; and transmit, to the first BS, a second response to the second handover request, wherein the second response indicates a handover preparation failure due to the cell of the second BS belonging to a mobile wireless network node.

In some embodiments of the present disclosure, the transceiver is further configured to transmit, to the first BS, an uplink (UL) backhaul adaptation protocol (BAP) configuration associated with a second distributed unit (DU) of a wireless network node, wherein the wireless network node includes a first DU having an F1 connection to the first BS and the second DU having an F1 connection to the second BS.

In some embodiments of the present disclosure, the UL BAP configuration is based on UL traffic information transmitted from the first BS to the second BS.

Some embodiments of the present disclosure provide a wireless network node. The wireless network node may include a processor; and a transceiver coupled to the processor. The transceiver may be configured to: receive, from a first base station (BS), configuration information about whether a cell(s) of the wireless network node supports an access from or a handover of a mobile wireless network node or not; and broadcast an indication of supporting an access from or a handover of a mobile wireless network node in a cell in response to the configuration information indicates that the cell supports an access from or a handover of a mobile wireless network node.

In some embodiments of the present disclosure, the transceiver is further configured to receive, from the first BS, a measurement configuration configuring a measurement with respect to a cell(s) of a second BS which is not a cell of a mobile wireless network node.

In some embodiments of the present disclosure, the transceiver is further configured to transmit a measurement report to the first BS, wherein: all the cells in the measurement report are not a cell of a mobile wireless network node; or for each cell in the measurement report, the measurement report includes an indication of whether a corresponding cell is a cell of a mobile wireless network node or not.

In some embodiments of the present disclosure, the wireless network node further includes a first distributed unit (DU) having an F1 connection to the first BS and a second DU having an F1 connection to a second BS, the first DU and the second DU are coupled to the processor. The transceiver is further configured to receive, from the first BS, an uplink (UL) backhaul adaptation protocol (BAP) configuration associated with the first DU and the second DU, and wherein each entry of the UL BAP configuration indicates whether the corresponding entry is applied to the first DU or the second DU.

Some embodiments of the present disclosure provide a mobile wireless network node. The mobile wireless network node may include a processor; and a transceiver coupled to the processor. The transceiver may be configured to: receive, from a first base station (BS), a measurement configuration configuring a measurement with respect to a cell(s) of a second BS which supports an access from or a handover of a mobile wireless network node; and transmit a measurement report to the first BS based on the measurement configuration.

In some embodiments of the present disclosure, the mobile wireless network node further includes a first distributed unit (DU) having a first F1 connection to the first BS. The mobile wireless network node may establish a second F1 connection between a second DU of the mobile wireless network node and the second BS while maintain the first F1 connection. The first DU and the second DU are coupled to the processor. The mobile wireless network node may receive, from the first BS, an uplink (UL) backhaul adaptation protocol (BAP) configuration associated with the first DU and the second DU, and wherein each entry of the UL BAP configuration indicates whether the corresponding entry is applied to the first DU or the second DU.

Some embodiments of the present disclosure provide a method performed by a first BS. The method may include: configuring a cell(s) of a first wireless network node whether to support an access from or a handover of a mobile wireless network node or not; and performing an integration procedure with a first mobile wireless network node via the first wireless network node, wherein at least one cell of the first wireless network node is configured to support an access from or a handover of a mobile wireless network node and the first wireless network node is a parent node of the first mobile wireless network node after the integration procedure.

Some embodiments of the present disclosure provide a method performed by a second BS. The method may include: receiving, from a first BS, a first handover request to hand over at least one UE served by a first mobile wireless network node, wherein for each of the at least one UE, the first handover request indicates at least one of: whether a corresponding UE is on board of a vehicle mounted by the first mobile wireless network node or surrounds the vehicle mounted by the first mobile wireless network node; or a handover priority level for the corresponding UE, wherein the first handover request is to hand over all connected UEs served by the first mobile wireless network node; and transmitting, to the first BS, a first response to the first handover request.

Some embodiments of the present disclosure provide a method performed by a wireless network node. The method may include: receiving, from a first base station (BS), configuration information about whether a cell(s) of the wireless network node supports an access from or a handover of a mobile wireless network node or not; and broadcasting an indication of supporting an access from or a handover of a mobile wireless network node in a cell in response to the configuration information indicates that the cell supports an access from or a handover of a mobile wireless network node.

Some embodiments of the present disclosure provide a method performed by a mobile wireless network node. The method may include: receiving, from a first base station (BS), a measurement configuration configuring a measurement with respect to a cell(s) of a second BS which supports an access from or a handover of a mobile wireless network node; and transmitting a measurement report to the first BS based on the measurement configuration.

Some embodiments of the present disclosure provide an apparatus. According to some embodiments of the present disclosure, the apparatus may include: at least one non-transitory computer-readable medium having stored thereon computer-executable instructions; at least one receiving circuitry; at least one transmitting circuitry; and at least one processor coupled to the at least one non-transitory computer-readable medium, the at least one receiving circuitry and the at least one transmitting circuitry, wherein the at least one non-transitory computer-readable medium and the computer executable instructions may be configured to, with the at least one processor, cause the apparatus to perform a method according to some embodiments of the present disclosure.

Embodiments of the present disclosure provide technical solutions to facilitate and improve the implementation of various communication technologies, such as 5G NR.

### BRIEF DESCRIPTION OF THE DRAWINGS

In order to describe the manner in which the advantages and features of the disclosure can be obtained, a description of the disclosure is rendered by reference to specific embodiments thereof, which are illustrated in the appended drawings. These drawings depict only exemplary embodiments of the disclosure and are not therefore to be considered limiting of its scope.

FIG. 1 illustrates a schematic diagram of a wireless communication system in accordance with some embodiments of the present disclosure;

FIGS. 2 and 3 illustrate example block diagrams of a protocol stack for an IAB network in accordance with some embodiments of the present disclosure;

FIG. 4 illustrates a flow chart of an exemplary configuration procedure in accordance with some embodiments of the present disclosure;

FIGS. 5 and 6 illustrate flow charts of exemplary handover procedures in accordance with some embodiments of the present disclosure;

FIG. 7 illustrates a flow chart of an exemplary configuration procedure in accordance with some embodiments of the present disclosure;

FIG. 8 illustrates a flow chart of an exemplary handover procedure in accordance with some embodiments of the present disclosure;

FIGS. 9-12A illustrate flow charts of exemplary procedures of wireless communications in accordance with some embodiments of the present disclosure; and

FIG. 13 illustrates a block diagram of an exemplary apparatus in accordance with some embodiments of the present disclosure.

### DETAILED DESCRIPTION

The detailed description of the appended drawings is intended as a description of the preferred embodiments of the present disclosure and is not intended to represent the only form in which the present disclosure may be practiced. It should be understood that the same or equivalent functions may be accomplished by different embodiments that are intended to be encompassed within the spirit and scope of the present disclosure.

Reference will now be made in detail to some embodiments of the present disclosure, examples of which are illustrated in the accompanying drawings. To facilitate understanding, embodiments are provided under specific network architectures and new service scenarios, such as the 3rd generation partnership project (3GPP) 5G (NR), 3GPP long-term evolution (LTE) Release 8, and so on. It is contemplated that along with the developments of network architectures and new service scenarios, all embodiments in the present disclosure are also applicable to similar technical problems; and moreover, the terminologies recited in the present disclosure may change, which should not affect the principles of the present disclosure.

Compared with the 4G communication system, the 5G communication system has raised more stringent requirements for various network performance indicators, for example, a 1000-time capacity increase, wider coverage requirements, ultra-high reliability, ultra-low latency, etc. Considering the rich frequency resources of high-frequency carriers, the use of high-frequency small station deployments is becoming more and more popular in hotspot areas in order to meet the needs of 5G ultra-high capacity. However, high-frequency carriers have poor propagation characteristics, severe attenuation due to obstructions, and limited coverage. Therefore, the dense deployment of small stations is required. In addition, the deployment of optical fiber may be difficult and costly for these small stations. Therefore, an economical and convenient backhaul scheme is needed. Integrated access and backhaul (IAB) technology, whose access link(s) and backhaul link(s) may both use wireless transmission solutions to avoid fiber deployment, provides ideas for solving the above problems.

In an IAB network, a wireless network node such as a relay node (RN) or an IAB node or a wireless backhaul node/device can provide wireless access services for UEs. For example, a UE can connect to an IAB donor relayed by one or more IAB nodes. The IAB donor may also be called a donor node or a donor base station (e.g., DgNB, Donor gNodeB). In addition, the wireless link between an IAB donor and an IAB node, or the wireless link between different IAB nodes can be referred to as a “backhaul link.” The wireless network node in an IAB network may be stationary or mobile. Embodiments of the present disclosure can be applied to the wireless network node regardless of whether it is stationary or mobile.

An IAB node may include an IAB mobile terminal (MT) part and an IAB distributed unit (DU) part. When an IAB node connects to its parent node (which may be another IAB node or an IAB donor), it can be regarded as a UE, i.e., the role of an MT. When an IAB node provides service to its child node (which may be another IAB node or a UE), it can be regarded as a network device, i.e., the role of a DU.

An IAB donor can be an access network element with a complete base station function, or an access network element with a separate form of a centralized unit (CU) and a distributed unit (DU). The IAB donor may be connected to the core network (for example, connected to the 5G core (5GC) network), and provide the wireless backhaul function for the IAB nodes. The CU of an IAB donor may be referred to as an “IAB donor-CU” (or directly referred to as a “CU”), and the DU of the IAB donor may be referred to as an “IAB donor-DU.” The IAB donor-CU may be separated into a control plane (CP) and a user plane (UP). For example, a CU may include one CU-CP and one or more CU-UPs.

Considering the limited coverage of a high frequency band, and in order to ensure coverage performance of the network, multi-hop networking may be adopted in an IAB network. Taking into account the requirements of service transmission reliability, IAB nodes can support dual connectivity (DC) or multi-connectivity to improve the transmission reliability, so as to deal with abnormal situations that may occur on the backhaul (BH) link, such as radio link failure (RLF) or blockage, load fluctuations, etc.

In the case where an IAB network supports multi-hop and dual-connection networking, there may be multiple transmission paths between the UE and the IAB donor. A transmission path may include multiple nodes, such as a UE, one or more IAB nodes, and an IAB donor (if the IAB donor is in the form of a separate CU and DU, it may also contain an IAB donor-DU and an IAB donor-CU). Each IAB node may treat the neighboring node that provides backhaul services for it as a parent node (or parent IAB node), and each IAB node can be regarded as a child node (or child IAB node) of its parent node.

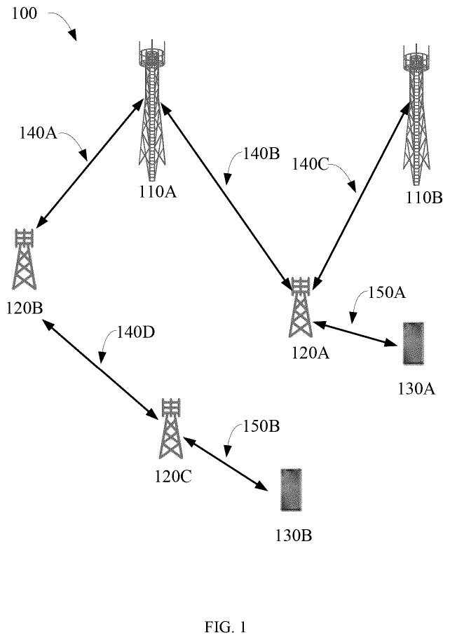

FIG. 1 illustrates a schematic diagram of wireless communication system 100 in accordance with some embodiments of the present disclosure.

As shown in FIG. 1, the wireless communication system 100 may include some base stations (e.g., IAB donor 110A and IAB donor 110B), some IAB nodes (e.g., IAB node 120A, IAB node 120B, and IAB node 120C), and some UEs (e.g., UE 130A and UE 130B). Although a specific number of UEs, IAB nodes, and IAB donors is depicted in FIG. 1, it is contemplated that any number of UEs, IAB nodes, and IAB donors may be included in the wireless communication system 100.

Each of IAB donor 110A, IAB donor 110B, IAB node 120A, IAB node 120B, and IAB node 120C may be directly connected to one or more IAB node(s) in accordance with some other embodiments of the present disclosure. Each of IAB donor 110A, IAB donor 110B, IAB node 120A, IAB node 120B, and IAB node 120C may be directly connected to one or more UEs in accordance with some other embodiments of the present disclosure.

UE 130A and UE 130B may be any type of device configured to operate and/or communicate in a wireless environment. For example, UE 130A and UE 130B may include a computing device, such as a desktop computer, a laptop computer, a personal digital assistant (PDA), a tablet computer, a smart television (e.g., television connected to the Internet), a set-top box, a game console, a security system (including a security camera), a vehicle on-board computer, a network device (e.g., router, switch, and modem), or the like. According to some embodiments of the present disclosure, UE 130A and UE 130B may include a portable wireless communication device, a smart phone, a cellular telephone, a flip phone, a device having a subscriber identity module, a personal computer, a selective call receiver, or any other device that is capable of transmission and receiving communication signals on a wireless network. In some embodiments of the present disclosure, UE 130A and UE 130B may include wearable devices, such as smart watches, fitness bands, optical head-mounted displays, internet-of-things (IoT) devices, or the like. Moreover, UE 130A and UE 130B may be referred to as a subscriber unit, a mobile, a mobile station, a user, a terminal, a mobile terminal, a wireless terminal, a fixed terminal, a subscriber station, a user terminal, or a device, or described using other terminology used in the art.

IAB donors 110A and 110B may be in communication with a core network (not shown in FIG. 1). The core network (CN) may include a plurality of core network components, such as a mobility management entity (MME) (not shown in FIG. 1) or an access and mobility management function (AMF) (not shown in FIG. 1). The CNs may serve as gateways for the UEs to access a public switched telephone network (PSTN) and/or other networks (not shown in FIG. 1).

Wireless communication system 100 may be compatible with any type of network that is capable of transmitting and receiving wireless communication signals. For example, the wireless communication system 100 is compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G network, a satellite communications network, a high altitude platform network, and/or other communications networks.

In some embodiments of the present disclosure, the wireless communication system 100 is compatible with 5G NR of the 3GPP protocol. For example, IAB donors 110A and 110B may transmit data using an orthogonal frequency division multiple (OFDM) modulation scheme on the DL. UE 130A and UE 130B may transmit data on the UL using a discrete Fourier transform-spread-orthogonal frequency division multiplexing (DFT-S-OFDM) or cyclic prefix-OFDM (CP-OFDM) scheme. More generally, however, the wireless communication system 100 may implement some other open or proprietary communication protocols, for example, WiMAX, among other protocols.

Persons skilled in the art should understand that as technology develops and advances, the terminologies described in the present disclosure may change, but should not affect or limit the principles and spirit of the present disclosure.

Referring to FIG. 1, IAB node 120A can be directly connected to IAB donors 110A and 110B, and IAB node 120B can be directly connected to IAB donor 110A. IAB donors 110A and 110B are parent nodes of IAB node 120A, and IAB donor 110A is a parent node of IAB node 120B. In other words, IAB nodes 120A and 120B are child IAB nodes of IAB donor 110A, and IAB node 120A is also a child IAB node of IAB donor 110B. IAB node 120C can reach IAB donor 110A by hopping through IAB node 120B. IAB node 120B is a parent IAB node of IAB node 120C. In other words, IAB node 120C is a child IAB node of IAB node 120B.

In some other embodiments of the present disclosure, an IAB node may be connected to IAB node 120C so it can reach IAB donor 110A by hopping through IAB node 120C and IAB node 120B. This IAB node and IAB node 120C may be referred to as the descendant IAB nodes of IAB node 120B.

UEs 130A and 130B can be connected to IAB nodes 120A and 120C, respectively. IAB nodes 120A and 120C may therefore be referred to as an access IAB node. Uplink (UL) packets (e.g., data or signaling) from UE 130A or UE 130B can be transmitted to an IAB donor (e.g., IAB donor 110A or 110B) via one or more IAB nodes, and then transmitted by the IAB donor to a mobile gateway device (such as the user plane function (UPF) in the 5GC). Downlink (DL) packets (e.g., data or signaling) can be transmitted from the IAB donor (e.g., IAB donor 110A or 110B) after being received by the gateway device, and then transmitted to UE 130A or 130B through one or more IAB nodes.

For example, referring to FIG. 1, UE 130A may transmit UL data to IAB donor 110A or 110B or receive DL data therefrom via IAB node 120A. UE 130B may transmit UL data to IAB donor 110A or receive DL data therefrom via IAB node 120C and IAB node 120B.

In an IAB deployment such as the wireless communication system 100, the radio link between an IAB donor (e.g., IAB donor 110A or 110B in FIG. 1) and an IAB node or between two IAB nodes may be referred to as a backhaul link (BL). The radio link between an IAB donor (e.g., IAB donor 110A or 110B in FIG. 1) and a UE or between an IAB node and a UE may be referred to as an access link (AL). For example, in FIG. 1, radio links 140A to 140D are BLs and radio links 150A and 150B are ALs.

A protocol layer, the backhaul adaptation protocol (BAP) layer, located above the radio link control (RLC) layer, is introduced in an IAB system and can be used to realize packet routing, bearer mapping and flow control on the wireless backhaul link.

An F1 interface may be established between an IAB node (e.g., DU part of the IAB node) and an IAB donor (e.g., IAB donor-CU). The F1 interface may support both a user plane protocol (e.g., F1-U) and a control plane protocol (e.g., F1-C). The user plane protocol of the Fl interface may include one or more of a general packet radio service (GPRS) tunneling protocol user plane (GTP-U), user datagram protocol (UDP), internet protocol (IP) and other protocols. The control plane protocol of the F1 interface may include one or more of an F1 application protocol (F1AP), stream control transport protocol (SCTP), IP, and other protocols.

Through the control plane of the F1 interface, an IAB node and an IAB donor can perform, for example, interface management, IAB-DU management, and a UE context-related configuration. Through the user plane of the F1 interface, an IAB node and an IAB donor can perform, for example, user plane data transmission and downlink transmission status feedback functions.

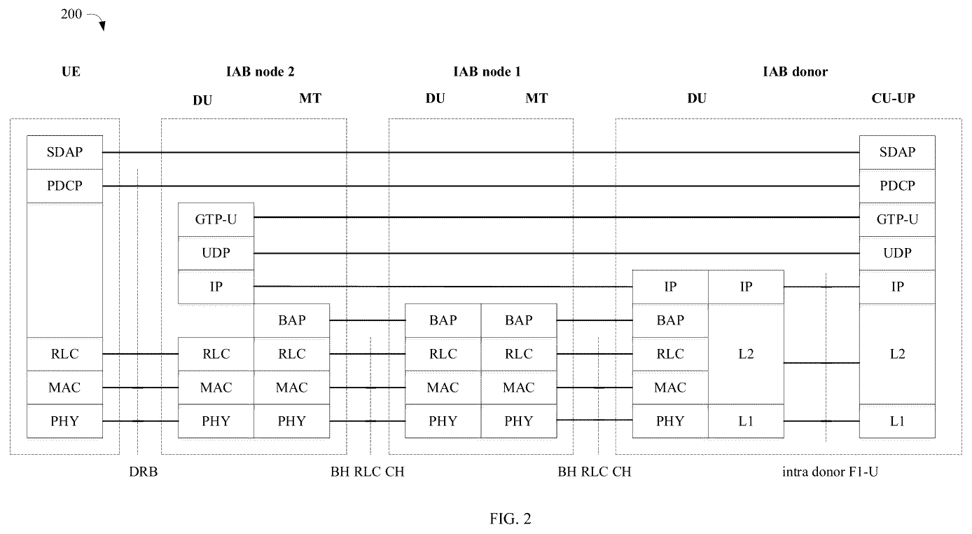

FIG. 2 illustrates an example block diagram of user plane (UP) protocol stack 200 for an IAB network according to some embodiments of the present disclosure. FIG. 3 illustrates an example block diagram of control plane (CP) protocol stack 300 for an IAB network according to some embodiments of the present disclosure. In FIGS. 2 and 3, a UE may be connected to an IAB donor via IAB node 2 and IAB node 1. In some other embodiments of the present disclosure, a UE may be connected to an IAB donor via more or less IAB nodes.

Referring to FIG. 2, the UP protocol stack of the UE may include a service data adaptation protocol (SDAP) layer, a packet data convergence protocol (PDCP) layer, a radio link control (RLC) layer, a medium access control (MAC) layer, and a physical (PHY) layer. The UP protocol stack of the DU of IAB node 2 may include a GTP-U layer, a UDP layer, an IP layer, an RLC layer, a MAC layer, and a PHY layer. The UP protocol stack of the MT of IAB node 2 or the DU or MT of IAB node 1 may include a BAP layer, an RLC layer, a MAC layer, and a PHY layer. The UP protocol stack of the DU of the IAB donor may include an IP layer, a BAP layer, an RLC layer, a MAC layer, and a PHY layer, where the PHY layer belongs to layer 1 (L1), and the BAP layer, the RLC layer, and the MAC layer belong to layer 2 (L2). The protocol stack of the CU-UP of the IAB donor may include a GTP-U layer, a UDP layer, an IP layer, an SDAP layer, a PDCP layer, an L2 layer(s), and an L1 layer.

Referring to FIG. 3, the CP protocol stack of the UE may include a radio resource control (RRC) layer, a PDCP layer, an RLC layer, a MAC layer, and a physical (PHY) layer. The CP protocol stack of the DU of IAB node 2 may include an F1AP layer, an SCTP layer, an IP layer, an RLC layer, a MAC layer, and a PHY layer. The CP protocol stack of the MT of IAB node 2 or the DU or MT of IAB node 1 may include a BAP layer, an RLC layer, a MAC layer, and a PHY layer. The CP protocol stack of the DU of the IAB donor may include an IP layer, a BAP layer, an RLC layer, a MAC layer, and a PHY layer, where the PHY layer belongs to L1, and the BAP layer, the RLC layer, and the MAC layer belong to L2. The protocol stack of the CU-CP of the IAB donor may include an RRC layer, a PDCP layer, an F1AP layer, an SCTP layer, an IP layer, an L2 layer(s), and an L1 layer.

The protocol stacks shown in FIGS. 2 and 3 are only for illustrative purposes. For example, the sequences of some of the protocol layers in the protocol stacks of FIGS. 2 and 3 may be rearranged for illustrative purposes. For example, although the SDAP and PDCP layers belong to L2, they are shown above the GTP-U layer, the UDP layer and the IP layer in the protocol stack of the CU-UP of the IAB donor in FIG. 2.

The signals between each node in an IAB network may include, for example, the following and can be applied to the present disclosure:
an IAB donor-CU and an IAB donor-DU: an F1AP message;
an IAB donor-CU and an IAB node: an F1AP message between the CU and the IAB-DU or an RRC message between the CU and the IAB-MT;
an IAB donor-CU and a UE: an RRC message;
an access IAB node and a UE: L2 control PDU such as a MAC control element (CE) or a RLC control PDU; and
an IAB node and another child or parent IAB node: L2 control PDU such as a MAC CE, a RLC control PDU, or a BAP control PDU.

As demand for improved cellular coverage and connectivity continues to increase, communications in outdoor and mobility scenarios may face more challenges. In some embodiments of the present disclosure, a mobile wireless network node which acts as a relay between a UE and the 3GPP communication network (e.g., 5G) may be employed to facilitate communications in such scenarios. The mobile wireless network node may provide, for example, an access link to UEs and connected wirelessly (e.g., using NR) through a BS (e.g., donor next-generation radio access network (NG-RAN)) to the core network. In some examples, such mobile wireless network node may also be referred to as a mobile base station relay or mobile relay. The above descriptions with respect to the wireless network node and the IAB node can be applied to the mobile base station relay. That is, a mobile base station relay can be a mobile IAB node.

In some examples, the mobile base station relay may be mounted on a vehicle. The mobile base station relay may serve UEs that are located inside (onboard) or outside (surrounding) the vehicle, or UEs that enter or leave the vehicle. In the context of the present disclosure, inside or outside of a mobile base station relay may mean inside or outside of a vehicle or other device(s) on which the mobile wireless network node is mounted.

In some examples, the radio link used between a mobile base station relay and the served UEs, as well as between the mobile base station relay and the BS, may be a Uu link (e.g., NR-Uu), which is different from a UE relay (which uses a PC5-based link to provide, for example, indirect connection to remote UEs). In some examples, there may be at least one hop between a UE and a mobile base station relay. In some examples, there may be at least one hop between a mobile base station relay and a BS.

The employment of such mobile wireless network node is advantageous in various aspects and can be applied to various scenarios. For example, in some outdoor environments, the availability of vehicles equipped with mobile base station relays, either following a certain known/predictable itinerary (e.g., buses, trams, etc.), or situated in convenient locations (e.g., outside stadiums, hot-spot areas, or emergency sites), may provide a very opportunistic boost to cellular coverage and capacity when or where needed. Those relays may use, for example, a 5G wireless backhaul toward the macro network, and thus can offer better coverage and connectivity to neighboring UEs. Mobile relays are also very suitable for improving connectivity for users or devices inside a vehicle on which the mobile relay is mounted in different environments, for example, for passengers in buses, cars/taxis, or trains, ad-hoc/professional personnel or equipment. Such mobile wireless network node can also be used for reaching users or devices that would otherwise have no or very poor macro coverage, for example, in the case of first responders dislocated in indoor buildings/areas, using relays placed on their nearby or outside vehicles to get required coverage and connectivity.

The technical benefits of using such mobile wireless network node further include, among others, the ability to get better macro coverage than a nearby UE, for example, exploiting better radio frequency, antenna and power capabilities. In addition, besides the value for network operators and end users, worthy incentives may be found for other parties as well, for example, for vehicle manufacturers, and vehicle and fleet owners or providers, to install and operate relays in their vehicles.

In the context of the present disclosure, a wireless network node may refer to either a stationary or mobile wireless network node.

Due to the mobility of a wireless network node (e.g., an IAB node), the wireless network node may need to migrate (or hand over) from one IAB donor to another IAB donor (i.e., Inter-donor migration).

In some embodiments, the MT of a wireless network node may migrate from an initial (source) IAB donor to a new (target) IAB donor. For example, the MT of a wireless network node may migrate to a different parent node underneath a different CU of an IAB donor. For instance, referring back to FIG. 1, the MT of IAB node 120C or IAB node 120B may migrate from IAB donor 110A to IAB donor 110B. In this scenario, the DU of the wireless network node and the DU of the descendant node(s) of the wireless network node may retain F1 connectivity with the source IAB donor (e.g., CU of the source IAB donor). This migration may be referred to as inter-donor partial migration. The wireless network node which performs inter-donor partial migration, may be referred to as a boundary wireless network node. After the inter-donor partial migration, the F1 traffic of the DU of the wireless network node and the DU of the descendant node(s) of the wireless network node may be routed via, for example, the BAP layer of the IAB topology to which the MT of the wireless network node has migrated.

In some embodiments, the DU of a wireless network node may migrate from an initial (source) IAB donor to a new (target) IAB donor. This migration may be referred to as inter-donor IAB-DU migration. In some embodiments, to execute the handover of the UEs served by the wireless network node (e.g., its DU), the wireless network node may concurrently support two logical DUs (e.g., DU #1 and DU #2), which may have F1AP associations with the source IAB donor (e.g., CU of the source IAB donor) and the target IAB donor (e.g., CU of the target IAB donor), respectively. The UEs connected to the wireless network node may be handed over from a cell of DU #1 (i.e., the source DU of the wireless network node) to a cell of DU #2 (i.e., the target DU of the wireless network node). After the migration of the DU of the wireless network node, the F1 interface between DU #1 and source IAB donor can be released.

Embodiments of the present disclosure provide solutions for facilitating the integration and handover of a mobile wireless network node. For example, it would be advantageous to know whether a cell supports an access from or a handover of a mobile wireless network node or not such that a mobile wireless network node would not access or be handed over to a cell not supporting a mobile wireless network node (e.g., certain IAB donors or parent IAB nodes may not support functionalities and characteristics related to a mobile IAB node).

Embodiments of the present disclosure provide solutions for facilitating the integration and handover of a wireless network node. For example, as a mobile wireless network node cannot serve as a parent node for a wireless network node (e.g., a mobile IAB node should serve only UEs and should have no descendent IAB nodes), it would be advantageous that a wireless network node can know whether a target cell associated with the handover is a cell of a mobile wireless network node.

Embodiments of the present disclosure provide solutions for UL BAP configuration when a wireless network node concurrently supports two DUs so as to be compatible with BAP behavior.

Embodiments of the present disclosure provide solutions for facilitating the handover of a UE(s) served by a mobile wireless network node. For example, for UEs served by a mobile wireless network node having different location relationships with respect to the mobile wireless network node (e.g., with respect to a vehicle on which the mobile wireless network node is mounted), a target cell associated with the handover may act differently. Moreover, an admission control may be performed at the target cell. Embodiments of the present disclosure provide assistance information to facilitate the handover of the UEs served by a mobile wireless network node.

More details on the embodiments of the present disclosure will be illustrated in the following text in combination with the appended drawings.

It should be noted that, although embodiments of the present disclosure are discussed under a specific network architecture (e.g., the IAB architecture) and based on certain specific components (e.g., an IAB donor or a mobile IAB node), embodiments of the present disclosure are also applicable to other similar network architectures and new service scenarios.

In some embodiments of the present disclosure, to facilitate the integration of a mobile wireless network node, a BS may indicate whether a cell(s) of the BS supports an access from a mobile wireless network node or not, such that a mobile wireless network node can access a mobile-wireless-network-node-capable cell or BS. In the context of the present disclosure, a cell of a BS may refer to a cell of a DU of the BS (e.g., the DU of an IAB donor) or a cell of a descendent wireless network node of the BS (e.g., a cell of a DU of an IAB node served by the BS).

Similarly, to facilitate the handover of a mobile wireless network node, a BS may indicate whether a cell(s) of the BS supports a handover of a mobile wireless network node or not, such that the handover of a mobile wireless network node can be performed with respect to a mobile-wireless network node-capable cell/BS.

In some embodiments, whether a cell supports an access from a mobile wireless network node or not may be decoupled with whether the cell supports a handover of a mobile wireless network node or not. For example, supporting (or not supporting) an access from a mobile wireless network node may not necessarily mean supporting (or not supporting) a handover of a mobile wireless network node. For example, supporting (or not supporting) a handover of a mobile wireless network node may not necessarily mean supporting (or not supporting) an access from a mobile wireless network node. For example, independent indications may be employed to indicate whether a cell supports an access from a mobile wireless network node or not and whether the cell supports a handover of a mobile wireless network node or not.

In some embodiments, whether a cell supports an access from a mobile wireless network node or not may be coupled with whether the cell supports a handover of a mobile wireless network node or not. For example, supporting (or not supporting) an access from a mobile wireless network node may mean supporting (or not supporting) both an access from and a handover of a mobile wireless network node. For example, supporting (or not supporting) a handover of a mobile wireless network node may mean supporting (or not supporting) both an access from and a handover of a mobile wireless network node. For example, a single indication may be employed to indicate whether a cell supports an access from and a handover of a mobile wireless network node or not.

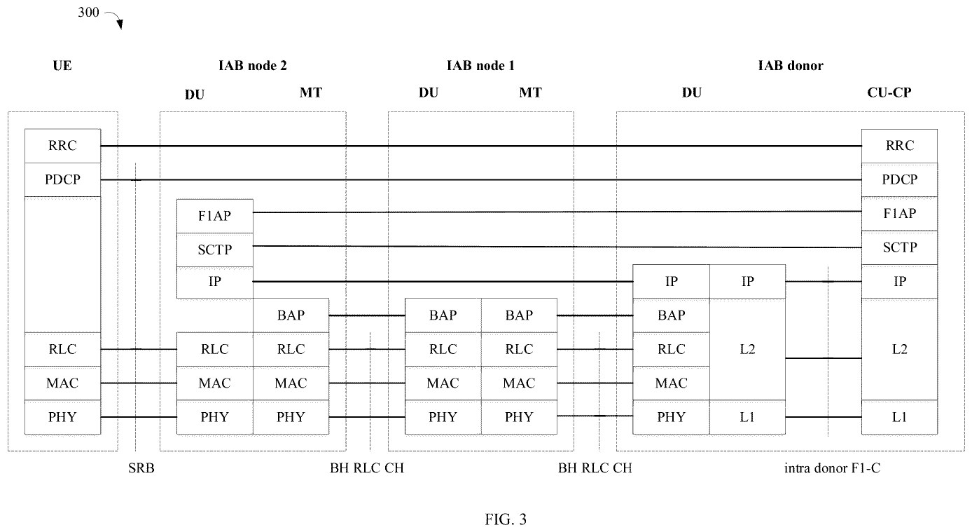

For example, FIG. 4 illustrates a flow chart of exemplary configuration procedure 400 in accordance with some embodiments of the present disclosure.

Details described in all of the foregoing embodiments of the present disclosure are applicable for the embodiments shown in FIG. 4. For example, BS 410 may function as the IAB donors as described above and may include a CU and at least one DU. Wireless network node 420A may function as the IAB nodes as described above, and may include an MT and a DU. In some embodiments, wireless network node 420A is a stationary (fixed) wireless network node. Mobile wireless network node 420B may function as a mobile IAB node as described above.

Wireless network node 420A (e.g., DU of wireless network node 420A) may have an F1 connection with BS 410 (e.g., CU of BS 410). BS 410 may be referred to as an F1 terminating BS of wireless network node 420A, respectively. In some examples, BS 410 may be the F1-terminating BS (e.g., CU of BS 410 being the F1-terminating CU) of wireless network node 420A in the case of partial migration of wireless network node 420A. In some examples, the MT of wireless network node 420A may have an RRC connection with BS 410 (e.g., CU of BS 410). That is, the F1-terminating BS and the RRC-terminating BS of wireless network node 420A are the same BS.

In operation 411, BS 410 (e.g., CU of BS 410) may configure a cell(s) of a wireless network node (e.g., wireless network node 420A) whether to support an access from or a handover of a mobile wireless network node or not. For example, BS 410 (e.g., CU of BS 410) may configure each cell of wireless network node 420A whether to support an access from or a handover of a mobile wireless network node or not via F1AP signaling.

In some embodiments, BS 410 may include a CU and a DU coupled to the CU. For example, BS 410 may be an IAB donor. In some embodiments, BS 410 (e.g., CU of BS 410) may configure a cell(s) of a DU of BS 410 whether to support an access from or a handover of a mobile wireless network node or not. For example, BS 410 (e.g., CU of BS 410) may configure each cell of the DU(s) of BS 410 whether to support an access from or a handover of a mobile wireless network node or not via F1AP signaling.

In the above embodiments, F1AP signaling such as “GNB-CU CONFIGURATION UPDATE,” “GNB-DU CONFIGURATION UPDATE ACKNOWLEDGE,” or “F1 SETUP RESPONSE” can be employed.

In some embodiments, the above configuration process can be performed per node (e.g., DU) granularity. All cells in a wireless network node (e.g., wireless network node 420A), a DU of a wireless network node, or a DU of a BS (e.g., DU of an IAB donor) may share the same configuration for mobile wireless network node access/handover control. For example, all cells of wireless network node 420A may share the same configuration for mobile wireless network node access/handover control. For example, all cells of wireless network node 420A allow an access from or a handover of a mobile wireless network node or none of the cells of wireless network node 420A allows an access from or a handover of a mobile wireless network node.

In some embodiments, the above configuration process can be performed per cell granularity. For example, a wireless network node, a DU of a wireless network node, or a DU of a BS may include one or more cells, each of which may have an independent configuration for mobile wireless network node access/handover control. For example, assuming that wireless network node 420A includes cell #1 and cell #2, cell #1 may be configured to allow an access from or a handover of a mobile wireless network node and cell #2 may be configured to forbid an access from or a handover of a mobile wireless network node.

Various manners may be employed to implement the configuration for mobile wireless network node access/handover control. In some embodiments, BS 410 may explicitly indicate an access from or a handover of a mobile wireless network node is allowed or not (e.g., not barred or barred). In some embodiments, not allowing an access from or a handover of a mobile wireless network node is a default configuration. BS 410 may perform the above configuration process to indicate support of an access from or a handover of a mobile wireless network node for a certain cell(s) or for a certain node(s). In some embodiments, allowing an access from or a handover of a mobile wireless network node is a default configuration. BS 410 may perform the above configuration process to indicate non-support of an access from or a handover of a mobile wireless network node for a certain cell(s) or for a certain node(s).

In some embodiments, BS 410 may support the functionalities related to a mobile wireless network node. In some embodiments, at least one cell of wireless network node 420A may be configured to support an access from or a handover of a mobile wireless network node. For a cell which is configured to support an access from or a handover of a mobile wireless network node, the cell of wireless network node 420A may broadcast an indication of supporting an access from or a handover of a mobile wireless network node in operation 413. For example, the indication can be a supporting mobile-IAB indication or a mobile-IAB-supported indication. For example, the indication may be included in system information, such as system information block 1 (SIB1).

In some embodiments, at least one cell of a DU of BS 410 may be configured to support an access from or a handover of a mobile wireless network node. Similarly, the at least one cell of the DU of the BS 410 may broadcast an indication of supporting an access from or a handover of a mobile wireless network node, for example, in SIB1.

In some embodiments, whether to support an access from or a handover of a mobile wireless network node may be pre-configured by an operation administration and maintenance (OAM) entity. A BS may reconfigure it via F1AP signaling.

In some embodiments, a mobile wireless network node may perform an integration procedure with BS 410 (e.g., CU of BS 410) and select wireless network node 420A or the DU of BS 410 as its parent node based on the broadcast indication as described above.

For example, mobile wireless network node 420B may perform an integration procedure with BS 410 (e.g., CU of BS 410) via wireless network node 420A in operation 415. In some embodiments, the integration procedure may include an MT setup procedure of mobile wireless network node 420B and a DU setup procedure of mobile wireless network node 420B, in which the MT of mobile wireless network node 420B sets up an RRC connection with BS 410 (e.g., CU of BS 410) and the DU of mobile wireless network node 420B sets up an F1 connection with BS 410 (e.g., CU of BS 410), respectively. In some embodiments, the integration procedure may include a BH RLC channel establishment and a routing update between mobile wireless network node 420B and BS 410 (e.g., CU of BS 410). After the integration procedure, wireless network node 420A is the parent node of mobile wireless network node 420B.

It should be appreciated by persons skilled in the art that the sequence of the operations in exemplary procedure 400 may be changed and some of the operations in exemplary procedure 400 may be eliminated or modified, without departing from the spirit and scope of the disclosure.

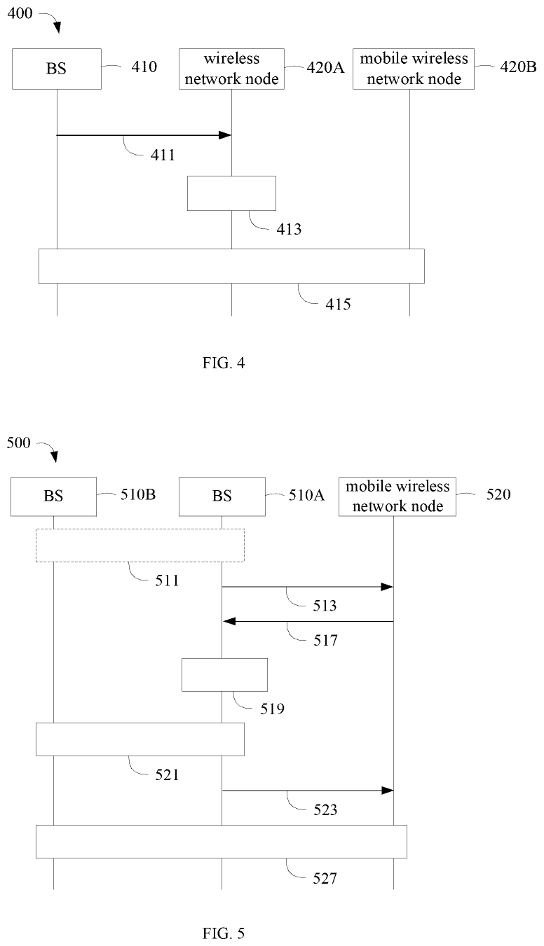

FIG. 5 illustrates a flow chart of exemplary handover procedure 500 in accordance with some embodiments of the present disclosure.

Details described in all of the foregoing embodiments of the present disclosure are applicable for the embodiments shown in FIG. 5. For example, BSs 510A and 510B may function as the IAB donors as described above and may include a CU and at least one DU. Mobile wireless network node 520 may function as the mobile IAB nodes as described above, and may include an MT and a DU. In some embodiments, BS 510A and mobile wireless network node 520 may function as BS 410 and mobile wireless network node 420B in FIG. 4.

Handover procedure 500 may be performed to facilitate the handover of a mobile wireless network node (e.g., mobile wireless network node 520) from a source BS (e.g., BS 510A) to a target BS (e.g., BS 510B). For example, the MT of mobile wireless network node 520 may be handed over from the CU of BS 510A to the CU of BS 510B.

In operation 511 (denoted in dotted block as an option), BS 510A and BS 510B may exchange information about whether the cell(s) of BS 510A, BS 510B or both support an access from or a handover of a mobile wireless network node or not.

For example, BS 510A may transmit, to BS 510B, information about whether a cell(s) of BS 510A supports an access from or a handover of a mobile wireless network node or not. For example, BS 510B may transmit, to BS 510A, information about whether a cell(s) of BS 510B supports an access from or a handover of a mobile wireless network node or not. A cell of a BS (e.g., BS 510A or BS 510B) may refer to a cell of a DU of the BS or a cell of a descendent wireless network node of the BS (e.g., a cell of a DU of a wireless network node served by the BS). For example, BS 510A may transmit, to BS 510B, information (denoted as information #1) about whether a cell(s) of a wireless network node (not shown in FIG. 5) served by BS 510A supports an access from or a handover of a mobile wireless network node or not. For example, BS 510A may transmit, to BS 510B, information (denoted as information #2) about whether a cell(s) of the DU of BS 510A supports an access from or a handover of a mobile wireless network node or not. For example, BS 510B may transmit, to BS 510A, information (denoted as information #3) about whether a cell(s) of a wireless network node (not shown in FIG. 5) served by BS 510B supports an access from or a handover of a mobile wireless network node or not. For example, BS 510B may transmit, to BS 510A, information (denoted as information #4) about whether a cell(s) of the DU of BS 510B supports an access from or a handover of a mobile wireless network node or not.

In some embodiments, the above information (e.g., any of information #1 to information #4) can be included in a “Served Cell Information” information element (IE) or a “Neighbour Information” IE of an XnAP signaling.

In operation 513, BS 510A (e.g., CU of BS 510A) may transmit a measurement configuration to mobile wireless network node 520. In operation 517, mobile wireless network node 520 may transmit a measurement report to BS 510A (e.g., CU of BS 510A). In operation 519, BS 510A (e.g., CU of BS 510A) may determine to hand over mobile wireless network node 520 (e.g., MT of mobile wireless network node 520) to a target cell based on the measurement report. For example, in operation 521, a handover preparation procedure for mobile wireless network node 520 may be performed between BS 510A and BS 510B. For example, BS 510A (e.g., CU of BS 510A) may transmit a handover request to BS 510B (e.g., CU of BS 510B) to hand over mobile wireless network node 520, and BS 510B (e.g., CU of BS 510B) may transmit a response to the handover request (e.g., positive feedback such as a handover request acknowledge message or negative feedback such as a handover preparation failure message) to BS 510A.

In some embodiments, operation 511 may be performed and the measurement configuration in operation 513 may be based on information #3, information #4, or both. For example, the measurement configuration may configure a measurement with respect to a cell(s) of BS 510B (e.g., a cell(s) of a wireless network node served by BS 510B or a cell(s) of the DU of BS 510B) which supports an access from or a handover of a mobile wireless network node. That is, BS 510A may only configure a measurement(s) to mobile wireless network node 520 with the cells of a neighbor BS (e.g., BS 510B) which allow the access from or handover of a mobile wireless network node.

In some embodiments, mobile wireless network node 520 (e.g., MT of mobile wireless network node 520) may receive and decode system information (e.g., SIB1) of a neighbor cell(s) (e.g., a cell(s) of BS 510B). In some embodiments, the system information may include an indication of supporting an access from or a handover of a mobile wireless network node in the neighbor cell. The measurement report in operation 517 may be based on such indication. In these embodiments, operation 511 may or may not be performed. In some embodiments, all cells in the measurement report may support a handover of a mobile wireless network node. That is, mobile wireless network node 520 may only transmit the measurement report associated with the cells which allow a handover of a mobile wireless network node to BS 510A. In some embodiments, for each cell in the measurement report, the measurement report may include an indication of whether a corresponding cell supports a handover of a mobile wireless network node or not.

In some embodiments, BS 510A may receive a handover preparation failure message from BS 510B in operation 521. This may be caused by the target cell of the handover request not supporting a handover of a mobile wireless network node. For example, when operation 511 is not performed, BS 510A cannot obtain information #3 or information #4, and may select a target cell not supporting a handover of a mobile wireless network node for handing over mobile wireless network node 520. BS 510B may refuse the handover and may respond with a handover preparation failure, which may indicate a cause value of a target cell of the handover request not supporting a handover of a mobile wireless network node.

In some embodiments, BS 510B may accept the handover and may transmit a handover request acknowledge message to BS 510A in operation 521. In response to receiving the handover request acknowledge message, BS 510A may, in operation 523, transmit a handover command to mobile wireless network node 520 to hand over mobile wireless network node 520 to BS 510B (e.g., a target cell of BS 510B, which may be a cell of a wireless network node served by BS 510B or a cell of the DU of BS 510B).

In operation 527, mobile wireless network node 520 may be handed over from BS 510A to BS 510B. In some examples, the target cell of the handover is a cell of a wireless network node served by BS 510B. After the completion of the handover, this wireless network node is the parent node of mobile wireless network node 520.

It should be appreciated by persons skilled in the art that the sequence of the operations in exemplary procedure 500 may be changed and some of the operations in exemplary procedure 500 may be eliminated or modified, without departing from the spirit and scope of the disclosure.

In some embodiments of the present disclosure, to facilitate the handover of a wireless network node, a BS may indicate whether a cell(s) of the BS supports a handover of a wireless network node or not, such that the handover of a wireless network node can be performed with respect to a wireless network node-capable cell/BS. For example, a wireless network node should not be handed over to a mobile wireless network node.

FIG. 6 illustrates a flow chart of exemplary handover procedure 600 in accordance with some embodiments of the present disclosure.

Details described in all of the foregoing embodiments of the present disclosure are applicable for the embodiments shown in FIG. 6. For example, BSs 610A and 610B may function as the IAB donors as described above and may include a CU and at least one DU. Wireless network node 620 may function as the IAB nodes as described above, and may include an MT and a DU. In some embodiments, wireless network node 620 is a stationary (fixed) wireless network node.

Handover procedure 600 may be performed to facilitate the handover of a wireless network node (e.g., wireless network node 620) from a source BS (e.g., BS 610A) to a target BS (e.g., BS 610B). For example, the MT of wireless network node 620 may be handed over from the CU of BS 610A to the CU of BS 610B.

In operation 611 (denoted in dotted block as an option), BS 610A and BS 610B may exchange information about whether a cell(s) of BS 610A, BS 610B or both is a cell of a mobile wireless network node or not. Put another way, BS 610A and BS 610B may exchange information about whether a cell(s) of BS 610A, BS 610B or both belongs to a mobile wireless network node or not.

For example, BS 610A may transmit, to BS 610B, information (denoted as information #5) about whether a cell(s) of BS 610A is a cell of a mobile wireless network node or not. For example, BS 610B may transmit, to BS 610A, information (denoted as information #6) about whether a cell(s) of BS 610B is a cell of a mobile wireless network node or not. For example, as a cell of a BS (e.g., BS 610A or BS 610B) may refer to a cell of a descendent wireless network node of the BS (e.g., a cell of a DU of a wireless network node served by the BS), the descendent wireless network node served by the BS may be a mobile wireless network node, which should have no descendent wireless network node.

In some embodiments, the above information (e.g., information #5, information #6 or both) can be included in a “Served Cell Information” IE or a “Neighbour Information” IE of an XnAP signaling.

In operation 613, BS 610A (e.g., CU of BS 610A) may transmit a measurement configuration to wireless network node 620. In operation 617, wireless network node 620 may transmit a measurement report to BS 610A (e.g., CU of BS 610A). In operation 619, BS 610A (e.g., CU of BS 610A) may determine to hand over wireless network node 620 (e.g., MT of wireless network node 620) to a target cell based on the measurement report. For example, in operation 621, a handover preparation procedure for wireless network node 620 may be performed between BS 610A and BS 610B. For example, BS 610A (e.g., CU of BS 610A) may transmit a handover request to BS 610B (e.g., CU of BS 610B) to hand over wireless network node 620, and BS 610B (e.g., CU of BS 610B) may transmit a response to the handover request (e.g., positive feedback such as a handover request acknowledge message or negative feedback such as a handover preparation failure message) to BS 610A.

In some embodiments, operation 611 may be performed and the measurement configuration in operation 613 may be based on information #6. For example, the measurement configuration may configure a measurement with respect to a cell(s) of BS 610B (e.g., a cell(s) of a wireless network node served by BS 610B or a cell(s) of the DU of BS 610B) which is not a cell of a mobile wireless network node. That is, BS 610A may only configure a measurement(s) to wireless network node 620 with the cells of a neighbor BS (e.g., BS 610B) which do not belong to a mobile wireless network node(s).

In some embodiments, wireless network node 620 (e.g., MT of mobile wireless network node 620) may receive and decode system information (e.g., SIB1) of a neighbor cell(s) (e.g., a cell(s) of BS 610B). In some embodiments, the system information may include an indication of whether the neighbor cell is a cell of a mobile wireless network node or not. The measurement report in operation 617 may be based on such indication. In these embodiments, operation 611 may or may not be performed. In some embodiments, all cells in the measurement report are not cells of a mobile wireless network node. That is, wireless network node 620 may only transmit the measurement report associated with the cells which do not belong to a mobile wireless network node to BS 610A. In some embodiments, for each cell in the measurement report, the measurement report may include an indication of whether a corresponding cell is a cell of a mobile wireless network node or not.

In some embodiments, BS 610A may receive a handover preparation failure message from BS 610B in operation 621. This may be caused by the target cell of the handover request belonging to a mobile wireless network node. For example, when operation 611 is not performed, BS 610A cannot obtain information #6, and may select a target cell belonging to a mobile wireless network node for handing over wireless network node 620. BS 610B may refuse the handover and may respond with a handover preparation failure, which may indicate a cause value of a target cell of the handover request belonging to a mobile wireless network node.

In some embodiments, BS 610B may accept the handover and may transmit a handover request acknowledge message to BS 610A in operation 621. In response to receiving the handover request acknowledge message, BS 610A may, in operation 623, transmit a handover command to wireless network node 620 to hand over wireless network node 620 to BS 610B (e.g., a target cell of BS 610B, which may be a cell of a (stationary) wireless network node served by BS 610B or a cell of the DU of BS 610B).

In operation 627, wireless network node 620 may be handed over from BS 610A to BS 610B. In some examples, the target cell of the handover is a cell of a stationary wireless network node served by BS 610B. After the completion of the handover, the stationary wireless network node is the parent node of wireless network node 620.

It should be appreciated by persons skilled in the art that the sequence of the operations in exemplary procedure 600 may be changed and some of the operations in exemplary procedure 600 may be eliminated or modified, without departing from the spirit and scope of the disclosure.

As mentioned above, in certain scenarios, a (stationary or mobile) wireless network node may include two DUs having F1AP associations with different BSs. Embodiments of the present disclosure provide a mechanism for UL BAP configuration for such wireless network node so as to be compatible with the BAP behavior.

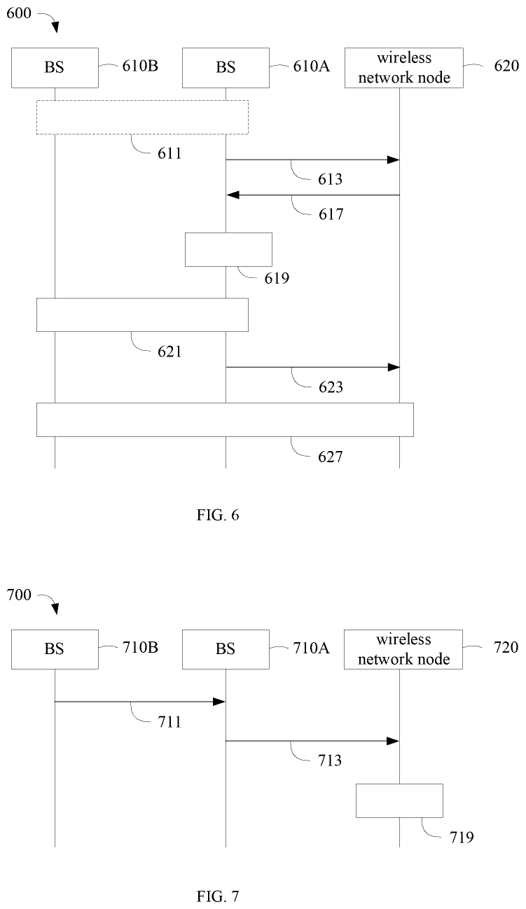

For example, FIG. 7 illustrates a flow chart of exemplary configuration procedure 700 in accordance with some embodiments of the present disclosure.

Details described in all of the foregoing embodiments of the present disclosure are applicable for the embodiments shown in FIG. 7. For example, BSs 710A and 710B may function as the IAB donors as described above and may include a CU and at least one DU. Wireless network node 720 may function as the IAB nodes as described above, and may include an MT and a DU. Wireless network node 720 may be a stationary or mobile wireless network node.

Wireless network node 720 may include two DUs (denoted as DU #A and DU #B), wherein DU #A may have an F1 connection to BS 710A (i.e., source F1 terminating BS), and DU #B may have an F1 connection to BS 710B (i.e., target F1 terminating BS). The MT of wireless network node 720 may have an RRC connection to BS 710A, BS 710B or another BS (not shown in FIG. 7).

In some embodiments of the present disclosure, the source F1 terminating BS (e.g., CU of the BS) configures the UL BAP configuration of a wireless network node (e.g., MT of the wireless network node). For example, BS 710A (e.g., CU of BS 710A) configures the UL BAP configuration associated with DU #A and the UL BAP configuration associated with DU #B for wireless network node 720. Since the two DUs are connected to different BSs (e.g., BS 710A and BS 710B), coordination between the BSs may be required.

For example, in operation 711, BS 710A (e.g., CU of BS 710A, which is the source F1 terminating CU) may receive, from BS 710B (e.g., CU of BS 710B, which is the target F1 terminating CU), a UL BAP configuration (denoted as configuration #B) associated with DU #B of wireless network node 720. Configuration #B can be applied to the UL traffic of DU #B and the UEs served by DU #B.

In some embodiments, configuration #B may include a traffic type specifier which may be indicated by a “UL UP transport network layer (TNL) Information” IE for F1-U packets and a “Non-UP Traffic Type” IE for non-F1-U packets, and a BAP routing ID for the traffic type specifier. In some embodiments, configuration #B may be based on UL traffic information transmitted from BS 710A to the BS 710B.

In operation 713, BS 710A (e.g., CU of BS 710A) may transmit a UL BAP configuration (denoted as configuration #A) to wireless network node 720. Configuration #A may be associated with DU #A and DU #B of wireless network node 720. For example, configuration #A may include entries associated with DU #B, which may be based on configuration #B received in operation 711. For example, configuration #A may include entries associated with DU #A, which may be generated by BS 710A (e.g., CU of BS 710A).

In some embodiments, each entry of configuration #A may include a traffic type specifier which may be indicated by a “UL UP TNL Information” IE for F1-U packets and a “Non-UP Traffic Type” IE for non-F1-U packets, and a BAP routing ID for the traffic type specifier.

In some embodiments, each entry of configuration #A may indicate whether the corresponding entry is applied to DU #A or DU #B (or applied to BS 710A or BS 710B). Such indication can help wireless network node 720 to differentiate between configurations from a source F1 terminating CU (e.g., CU of BS 710A) and a target F1 terminating CU (e.g., CU of BS 710B). In some embodiments, a topology indicator for each entry (e.g., a “Non-F1-terminating IAB-donor Topology Indicator” IE) may be reused to differentiate between a source F1 terminating CU and a target F1 terminating CU.

In operation 719, wireless network node 720 may perform BAP mapping based on configuration #A. For example, based on the traffic type specifier in the header of UL traffic, the BAP entity of wireless network node 720 may select the corresponding BAP routing ID (e.g., a BAP address and a BAP path identity) for the UL traffic and include the selected BAP routing ID in the BAP header.

For example, for a BAP service data unit (SDU) received from an upper layer(s) of wireless network node 720 and to be transmitted in the upstream direction, the BAP entity of wireless network node 720 may:
for the BAP SDU encapsulating an F1-U packet, select an entry from configuration #A with its traffic type specifier corresponding to the destination IP address and tunnel endpoint identifier (TEID) of this BAP SDU;
for the BAP SDU encapsulating a non-F1-U packet, select an entry from configuration #A with its traffic type specifier corresponding to the traffic type of this BAP SDU; and
select the BAP address and the BAP path identity from the BAP routing ID in the entry selected above.

It should be appreciated by persons skilled in the art that the sequence of the operations in exemplary procedure 700 may be changed and some of the operations in exemplary procedure 700 may be eliminated or modified, without departing from the spirit and scope of the disclosure.

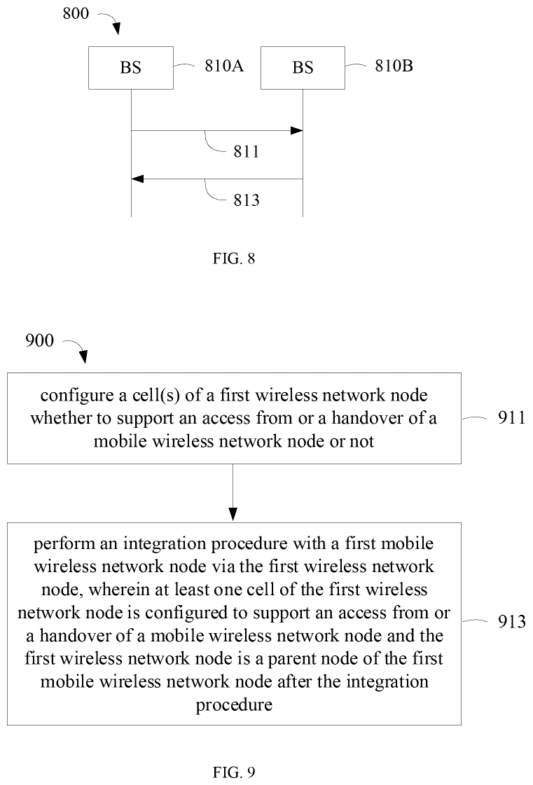

In some embodiments of the present disclosure, in the scenario of a mobile wireless network node migration, the UEs served by the mobile wireless network node may need to be handed over from the source BS to the target BS of the wireless network node. FIG. 8 illustrates a flow chart of exemplary handover procedure 800 in accordance with some embodiments of the present disclosure.

Details described in all of the foregoing embodiments of the present disclosure are applicable for the embodiments shown in FIG. 8. For example, BSs 810A and 810B may function as the IAB donors as described above and may include a CU and at least one DU.

In the example of FIG. 8, a mobile wireless network node (not shown) may migrate from BS 810A (i.e., source BS) to BS 810B (i.e., target BS). The mobile wireless network node may serve one or more UEs, which may be on board of a vehicle mounted by the mobile wireless network node or surround the vehicle mounted by the mobile wireless network node. The one or more UEs may also be handed over from BS 810A to BS 810B.

For example, in operation 811, BS 810A (e.g., CU of BS 810A) may transmit a handover request to BS 810B (e.g., CU of BS 810B) to hand over at least one UE served by the mobile wireless network node. In some embodiments, the handover request may be for an individual UE. For example, for each of the one or more UEs served by the mobile wireless network node, BS 810A may transmit a corresponding handover request to BS 810B. In some embodiments, the handover request may be for all the UEs (e.g., all UEs in an RRC connected state) served by the mobile wireless network node, which is referred to as “group mobility” hereinafter.

In some embodiments, the handover request may include the onboard or surrounding information of the UE(s) to be handed over. For example, for each of the at least one UE, the handover request may indicate whether a corresponding UE is on board of the vehicle mounted by the mobile wireless network node or surrounds the vehicle mounted by the mobile wireless network node.

In some embodiments, for each of the at least one UE, the handover request may indicate a handover priority level for the corresponding UE. The handover priority level(s) can be used in the case of group mobility (i.e., when handing over all connected UEs served by the mobile wireless network node in a single handover request). The handover priority level(s) can be used for admission control by BS 810B, for example, in the case of an overload.

In operation 813, BS 810B (e.g., CU of BS 810B) may transmit a response to the handover request (e.g., positive feedback such as a handover request acknowledge message or negative feedback such as a handover preparation failure message) to BS 810A.

In some embodiments, based on the onboard or surrounding information in the handover request, BS 810B (e.g., CU of BS 810B) may feed back with different RRC reconfigurations. For example, compared with the surrounding UE(s), there may be some optimizations on the onboard UE(s) and some configurations (e.g., random access channel (RACH) configuration) to the onboard UE(s) can be omitted.

In some embodiments, the onboard or surrounding information can be used for admission control, for example, in the case of group mobility. In some embodiments, the handover priority level(s) can be used for admission control, for example, in the case of group mobility.

For example, in the case of group mobility, an overload may occur at BS 810B. In some embodiments, BS 810B may preferentially admit the onboard UEs or the UEs with higher priority levels among the UEs to be handed over. In some embodiments, the response to the handover request (e.g., a handover request acknowledge message) in operation 813 may include at least one of a list of admitted UEs among the at least one UE to be handed over based on the onboard or surrounding information, the handover priority level, or both; or a list of refused UEs among the at least one UE to be handed over based on the onboard or surrounding information, the handover priority level, or both. In some embodiments, the refuse list may include a cause value of overload.

It should be appreciated by persons skilled in the art that the sequence of the operations in exemplary procedure 800 may be changed and some of the operations in exemplary procedure 800 may be eliminated or modified, without departing from the spirit and scope of the disclosure.

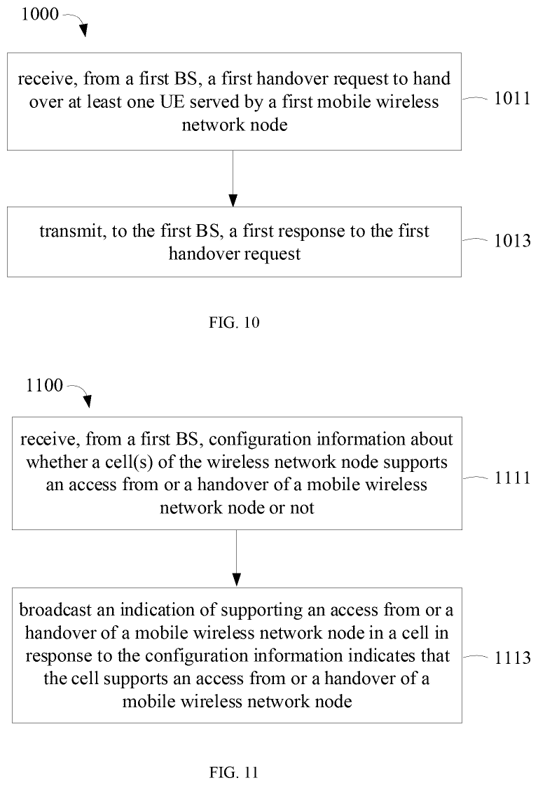

FIG. 9 illustrates a flow chart of exemplary procedure 900 for wireless communications in accordance with some embodiments of the present disclosure. Details described in all of the foregoing embodiments of the present disclosure are applicable for the embodiments shown in FIG. 9. Exemplary procedure 900 may be performed by a BS (e.g., an IAB donor).

Referring to FIG. 9, in operation 911, a first BS may configure a cell(s) of a first wireless network node whether to support an access from or a handover of a mobile wireless network node or not. In some examples, the first BS may be an IAB donor and the first wireless network node may be an IAB node. In some examples, the first wireless network node may be a stationary wireless network node. For example, descriptions with respect to FIG. 4 (e.g., operation 411) may apply here.

In some embodiments of the present disclosure, the first BS may include a CU and a DU coupled to the CU. The CU of the first BS may configure a cell(s) of the DU of the first BS whether to support an access from or a handover of a mobile wireless network node or not.

In operation 913, the first BS may perform an integration procedure with a first mobile wireless network node via the first wireless network node, wherein at least one cell of the first wireless network node is configured to support an access from or a handover of a mobile wireless network node and the first wireless network node is a parent node of the first mobile wireless network node after the integration procedure. In some examples, the first mobile wireless network node may be a mobile IAB node. For example, descriptions with respect to FIG. 4 (e.g., operation 415) may apply here.

In some embodiments of the present disclosure, the first BS may perform at least one of the following: transmitting, to a second BS, first information about whether the cell(s) of the first wireless network node supports an access from or a handover of a mobile wireless network node or not; transmitting, to the second BS, second information about whether a cell(s) of the DU supports an access from or a handover of a mobile wireless network node or not; receiving, from the second BS, third information about whether a cell(s) of a second wireless network node supports an access from or a handover of a mobile wireless network node or not, wherein the second wireless network node connects to the second BS; or receiving, from the second BS, fourth information about whether a cell(s) of a DU of the second BS supports an access from or a handover of a mobile wireless network node or not. For example, descriptions with respect to FIG. 5 (e.g., operation 511) may apply here.

In some embodiments of the present disclosure, the cell(s) of a BS (e.g., the first or second BS) may refer to a cell(s) of a wireless network node served by (or connected to) the BS or a cell(s) of the DU of the BS. For example, the cell(s) of the first wireless network node and the cell(s) of the DU of the first BS are cells of the first BS. For example, the cell(s) of the second wireless network node and a cell(s) of the DU of the second BS are cells of the second BS.

In some embodiments of the present disclosure, the first BS may transmit, to the first mobile wireless network node, a measurement configuration configuring a measurement with respect to a cell(s) of the second BS which supports an access from or a handover of a mobile wireless network node, wherein the measurement configuration is based on the third information, the fourth information, or both. For example, descriptions with respect to FIG. 5 (e.g., operation 513) may apply here.

In some embodiments of the present disclosure, the first BS may receive a measurement report from the first mobile wireless network node, wherein: all cells in the measurement report support a handover of a mobile wireless network node; or for each cell in the measurement report, the measurement report includes an indication of whether a corresponding cell supports a handover of a mobile wireless network node or not. For example, descriptions with respect to FIG. 5 (e.g., operation 517) may apply here.

In some embodiments of the present disclosure, the first BS may transmit, to a second BS, a handover request to hand over the first mobile wireless network node. The first BS may receive, from the second BS, a response to the handover request, wherein the response indicates a handover preparation failure due to a target cell of the handover request not supporting a handover of a mobile wireless network node. For example, descriptions with respect to FIG. 5 (e.g., operation 521) may apply here.

In some embodiments of the present disclosure, the first BS may perform at least one of the following: transmitting, to a second BS, first information about whether a cell(s) of the first BS is a cell of a mobile wireless network node or not; or receiving, from the second BS, second information about whether a cell(s) of the second BS is a cell of a mobile wireless network node or not. A cell being a cell of a mobile wireless network node may mean that the cell belongs to a mobile wireless network node. For example, descriptions with respect to FIG. 6 (e.g., operation 611) may apply here.

In some embodiments of the present disclosure, the first BS may transmit, to a second wireless network node, a measurement configuration configuring a measurement with respect to a cell(s) of the second BS which is not a cell of a mobile wireless network node, wherein the measurement configuration is based on the second information. The second wireless network node may or may not be the first wireless network node. For example, descriptions with respect to FIG. 6 (e.g., operation 613) may apply here.

In some embodiments of the present disclosure, the first BS may receive a measurement report from a second wireless network node, wherein: all the cells in the measurement report are not cells of a mobile wireless network node; or for each cell in the measurement report, the measurement report includes an indication of whether a corresponding cell is a cell of a mobile wireless network node or not. For example, descriptions with respect to FIG. 6 (e.g., operation 617) may apply here.

In some embodiments of the present disclosure, the first BS may transmit, to a second BS, a handover request to hand over a second wireless network node; and receive, from the second BS, a response to the handover request, wherein the response indicates a handover preparation failure due to a target cell of the handover request belonging to a mobile wireless network node. For example, descriptions with respect to FIG. 6 (e.g., operation 621) may apply here.

In some embodiments of the present disclosure, the first BS may receive, from a second BS, a first UL BAP configuration associated with a second DU of a third wireless network node, wherein the third wireless network node includes a first DU having an F1 connection to the first BS and the second DU having an F1 connection to the second BS. For example, descriptions with respect to FIG. 7 (e.g., operation 711) may apply here.

In some embodiments of the present disclosure, the first UL BAP configuration is based on UL traffic information transmitted from the first BS to the second BS.

In some embodiments of the present disclosure, the first BS may transmit a second UL BAP configuration associated with the first DU and the second DU to the third wireless network node, and wherein each entry of the second UL BAP configuration indicates whether the corresponding entry is applied to the first DU or the second DU (or applied to the first BS or the second BS). For example, descriptions with respect to FIG. 7 (e.g., operation 713) may apply here.

In some embodiments of the present disclosure, the first BS may transmit a handover request to a second BS to hand over at least one UE served by the first mobile wireless network node. For each of the at least one UE, the handover request indicates at least one of: whether a corresponding UE is on board of a vehicle mounted by the first mobile wireless network node or surrounds the vehicle mounted by the first mobile wireless network node; or a handover priority level for the corresponding UE, wherein the handover request is to hand over all connected UEs served by the first mobile wireless network node. For example, descriptions with respect to FIG. 8 (e.g., operation 811) may apply here.

In some embodiments of the present disclosure, the first BS may receive, from the second BS, a response to the handover request. The response includes at least one of: a list of admitted UEs among the at least one UE based on the handover priority level; or a list of refused UEs among the at least one UE based on the handover priority level. For example, descriptions with respect to FIG. 8 (e.g., operation 813) may apply here.

It should be appreciated by persons skilled in the art that the sequence of the operations in exemplary procedure 900 may be changed and some of the operations in exemplary procedure 900 may be eliminated or modified, without departing from the spirit and scope of the disclosure.

FIG. 10 illustrates a flow chart of exemplary procedure 1000 for wireless communications in accordance with some embodiments of the present disclosure. Details described in all of the foregoing embodiments of the present disclosure are applicable for the embodiments shown in FIG. 10. Exemplary procedure 1000 may be performed by a BS (e.g., an IAB donor).

Referring to FIG. 10, in operation 1011, a second BS may receive, from a first BS, a first handover request to hand over at least one UE served by a first mobile wireless network node. In some embodiments of the present disclosure, for each of the at least one UE, the first handover request may indicate at least one of: whether a corresponding UE is on board of a vehicle mounted by the first mobile wireless network node or surrounds the vehicle mounted by the first mobile wireless network node; or a handover priority level for the corresponding UE, wherein the first handover request is to hand over all connected UEs served by the first mobile wireless network node. For example, descriptions with respect to FIG. 8 (e.g., operation 811) may apply here.

In operation 1013, the second BS may transmit, to the first BS, a first response to the first handover request. For example, descriptions with respect to FIG. 8 (e.g., operation 813) may apply here.

In some embodiments of the present disclosure, the first response may include at least one of: a list of admitted UEs among the at least one UE based on the handover priority level; or a list of refused UEs among the at least one UE based on the handover priority level.

In some embodiments of the present disclosure, the second BS may perform at least one of the following: receiving, from the first BS, first information about whether a cell(s) of a first wireless network node supports an access from or a handover of a mobile wireless network node or not, wherein the first wireless network node connects to the first BS; receiving, from the first BS, second information about whether a cell(s) of a DU of the first BS supports an access from or a handover of a mobile wireless network node or not; transmitting, to the first BS, third information about whether a cell(s) of a second wireless network node supports an access from or a handover of a mobile wireless network node or not, wherein the second wireless network node connects to the second BS; or transmitting, to the first BS, fourth information about whether a cell(s) of a DU of the second BS supports an access from or a handover of a mobile wireless network node or not. For example, descriptions with respect to FIG. 5 (e.g., operation 511) may apply here.

In some embodiments of the present disclosure, the second BS may: receive, from the first BS, a second handover request to hand over the first mobile wireless network node; and transmit, to the first BS, a second response to the second handover request, wherein the second response indicates a handover preparation failure due to a target cell of the second handover request not supporting a handover of a mobile wireless network node. For example, descriptions with respect to FIG. 5 (e.g., operation 521) may apply here.

In some embodiments of the present disclosure, the second BS may perform at least one of the following: receiving, from the first BS, first information about whether a cell(s) of the first BS is a cell of a mobile wireless network node or not; or transmitting, to the first BS, second information about whether a cell(s) of the second BS is a cell of a mobile wireless network node or not. For example, descriptions with respect to FIG. 6 (e.g., operation 611) may apply here.

In some embodiments of the present disclosure, the second BS may: receive, from the first BS, a second handover request to hand over a wireless network node from the first BS to a cell of the second BS; and transmit, to the first BS, a second response to the second handover request, wherein the second response indicates a handover preparation failure due to the cell of the second BS belonging to a mobile wireless network node. For example, descriptions with respect to FIG. 6 (e.g., operation 621) may apply here.

In some embodiments of the present disclosure, the second BS may transmit, to the first BS, a UL BAP configuration associated with a second DU of a wireless network node, wherein the wireless network node includes a first DU having an F1 connection to the first BS and the second DU having an F1 connection to the second BS. In some embodiments of the present disclosure, the UL BAP configuration is based on UL traffic information transmitted from the first BS to the second BS. For example, descriptions with respect to FIG. 7 (e.g., operation 711) may apply here.

It should be appreciated by persons skilled in the art that the sequence of the operations in exemplary procedure 1000 may be changed and some of the operations in exemplary procedure 1000 may be eliminated or modified, without departing from the spirit and scope of the disclosure.

FIG. 11 illustrates a flow chart of exemplary procedure 1100 for wireless communications in accordance with some embodiments of the present disclosure. Details described in all of the foregoing embodiments of the present disclosure are applicable for the embodiments shown in FIG. 11. Exemplary procedure 1100 may be performed by a wireless network node (e.g., an IAB node), which may be stationary or mobile.

Referring to FIG. 11, in operation 1111, a wireless network node may receive, from a first BS, configuration information about whether a cell(s) of the wireless network node supports an access from or a handover of a mobile wireless network node or not. For example, descriptions with respect to FIG. 4 (e.g., operation 411) may apply here.

In operation 1113, the wireless network node may broadcast an indication of supporting an access from or a handover of a mobile wireless network node in a cell in response to the configuration information indicates that the cell supports an access from or a handover of a mobile wireless network node. For example, descriptions with respect to FIG. 4 (e.g., operation 413) may apply here.

In some embodiments of the present disclosure, the wireless network node may receive, from the first BS, a measurement configuration configuring a measurement with respect to a cell(s) of a second BS which is not a cell of a mobile wireless network node. For example, descriptions with respect to FIG. 6 (e.g., operation 613) may apply here.

In some embodiments of the present disclosure, the wireless network node may transmit a measurement report to the first BS, wherein: all the cells in the measurement report are not cells of a mobile wireless network node; or for each cell in the measurement report, the measurement report includes an indication of whether a corresponding cell is a cell of a mobile wireless network node or not. For example, descriptions with respect to FIG. 6 (e.g., operation 617) may apply here.

In some embodiments of the present disclosure, the wireless network node includes a first DU having an F1 connection to the first BS and a second DU having an F1 connection to a second BS. The wireless network node may receive, from the first BS, a UL BAP configuration associated with the first DU and the second DU, and wherein each entry of the UL BAP configuration indicates whether the corresponding entry is applied to the first DU or the second DU. For example, descriptions with respect to FIG. 7 (e.g., operation 713) may apply here.

It should be appreciated by persons skilled in the art that the sequence of the operations in exemplary procedure 1100 may be changed and some of the operations in exemplary procedure 1100 may be eliminated or modified, without departing from the spirit and scope of the disclosure.

FIG. 12 illustrates a flow chart of exemplary procedure 1200 for wireless communications in accordance with some embodiments of the present disclosure. Details described in all of the foregoing embodiments of the present disclosure are applicable for the embodiments shown in FIG. 12. Exemplary procedure 1200 may be performed by a mobile wireless network node (e.g., a mobile IAB node).

Referring to FIG. 12, in operation 1211, a mobile wireless network node may receive, from a first BS, a measurement configuration configuring a measurement with respect to a cell(s) of a second BS which supports an access from or a handover of a mobile wireless network node. For example, descriptions with respect to FIG. 5 (e.g., operation 513) may apply here.

In operation 1213, the mobile wireless network node may transmit a measurement report to the first BS based on the measurement configuration. For example, descriptions with respect to FIG. 5 (e.g., operation 517) may apply here.

In some embodiments of the present disclosure, the mobile wireless network node may include a first DU having a first F1 connection to the first BS. The mobile wireless network node may establish a second F1 connection between a second DU of the mobile wireless network node and the second BS while maintain the first F1 connection. For example, descriptions with respect to FIG. 7 may apply here. In some embodiments of the present disclosure, the mobile wireless network node may receive, from the first BS, a UL BAP configuration associated with the first DU and the second DU, and wherein each entry of the UL BAP configuration indicates whether the corresponding entry is applied to the first DU or the second DU.

It should be appreciated by persons skilled in the art that the sequence of the operations in exemplary procedure 1200 may be changed and some of the operations in exemplary procedure 1200 may be eliminated or modified, without departing from the spirit and scope of the disclosure.

FIG. 12A illustrates a flow chart of exemplary procedure 1200A for wireless communications in accordance with some embodiments of the present disclosure. Details described in all of the foregoing embodiments of the present disclosure are applicable for the embodiments shown in FIG. 12A. Exemplary procedure 1200A may be performed by a mobile wireless network node (e.g., a mobile IAB node).

Referring to FIG. 12A, in operation 1221, a mobile wireless network node may receive, from a first BS, a measurement configuration configuring a measurement with respect to a cell(s) of a second BS. For example, descriptions with respect to FIG. 5 (e.g., operation 513) may apply here.

In operation 1223, the mobile wireless network node may transmit a measurement report to the first BS based on the measurement configuration. For example, descriptions with respect to FIG. 5 (e.g., operation 517) may apply here. For example, in some embodiments of the present disclosure, all cells in the measurement report support a handover of a mobile wireless network node; or for each cell in the measurement report, the measurement report includes an indication of whether a corresponding cell supports a handover of a mobile wireless network node or not.

In some embodiments of the present disclosure, the mobile wireless network node may include a first DU having a first F1 connection to the first BS. The mobile wireless network node may establish a second F1 connection between a second DU of the mobile wireless network node and the second BS while maintain the first F1 connection. For example, descriptions with respect to FIG. 7 may apply here. In some embodiments of the present disclosure, the mobile wireless network node may receive, from the first BS, a UL BAP configuration associated with the first DU and the second DU, and wherein each entry of the UL BAP configuration indicates whether the corresponding entry is applied to the first DU or the second DU.

It should be appreciated by persons skilled in the art that the sequence of the operations in exemplary procedure 1200A may be changed and some of the operations in exemplary procedure 1200A may be eliminated or modified, without departing from the spirit and scope of the disclosure.

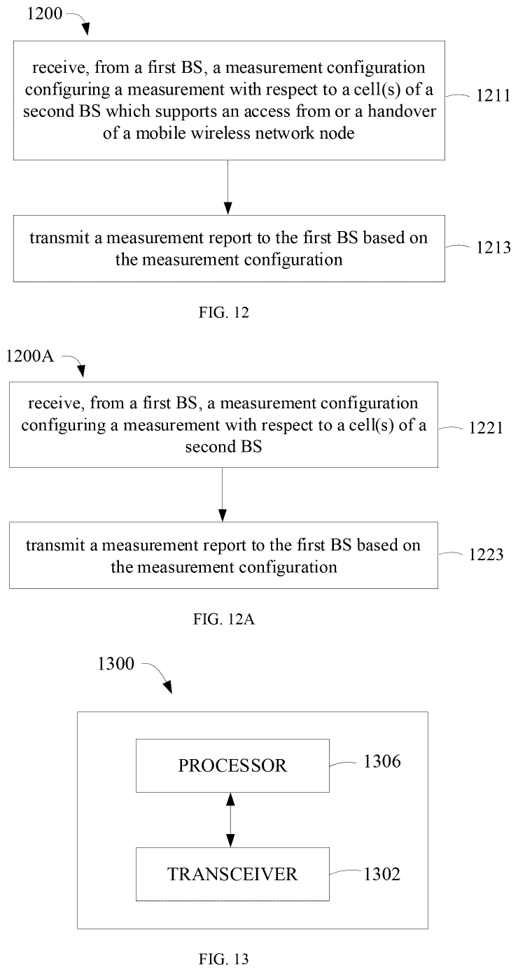

FIG. 13 illustrates a block diagram of exemplary apparatus 1300 according to some embodiments of the present disclosure.

As shown in FIG. 13, the apparatus 1300 may include at least one processor 1306 and at least one transceiver 1302 coupled to the processor 1306. The apparatus 1300 may be a wireless network node (e.g., an IAB node), a BS (e.g., an IAB donor, IAB donor-CU, or IAB donor-DU), a DU of a BS, or a CU of a BS. In the case that apparatus 1300 is a BS, apparatus 1300 may further include a CU and at least one DU coupled to the CU. The CU and DU may be co-located or located separately. The CU and DU may be coupled to the processor 1306. In the case that apparatus 1300 is a wireless network node (stationary or mobile), apparatus 1300 may further include an MT and a DU coupled to the MT. The MT and DU may be coupled to the processor 1306.

Although in this figure elements such as the at least one transceiver 1302 and processor 1306 are described in the singular, the plural is contemplated unless a limitation to the singular is explicitly stated. In some embodiments of the present application, the transceiver 1302 may be divided into two devices, such as a receiving circuitry and a transmitting circuitry. In some embodiments of the present application, the apparatus 1300 may further include an input device, a memory, and/or other components.

In some embodiments of the present application, the apparatus 1300 may be a BS. The processor 1306 may interact with other element(s) (e.g., transceiver 1302, a DU, or a CU) of the apparatus 1300 so as to perform the operations with respect to the BSs, the IAB donors, IAB donor-CUs, or IAB donor-DUs described in FIGS. 1-12A. In some embodiments of the present application, the apparatus 1300 may be a wireless network node. The transceiver 1302 and the processor 1306 may interact with each other so as to perform the operations with respect to the wireless network nodes or the IAB nodes (mobile or stationary) described in FIGS. 1-12A.

In some embodiments of the present application, the apparatus 1300 may further include at least one non-transitory computer-readable medium.

In some embodiments of the present disclosure, the non-transitory computer-readable medium may have stored thereon computer-executable instructions to cause the processor 1306 to implement the method with respect to the BSs, the IAB donors, IAB donor-CUs, or IAB donor-DUs as described above. For example, the computer-executable instructions, when executed, cause the processor 1306 interacting with, for example, transceiver 1302 to perform the operations with respect to the BSs, the IAB donors, IAB donor-CUs, or IAB donor-DUs described in FIGS. 1-12A.

For example, in some embodiments of the present disclosure, the non-transitory computer-readable medium may have stored thereon computer-executable instructions to cause the processor 1306 to implement the method with respect to the wireless network nodes or the IAB nodes (mobile or stationary) as described above. For example, the computer-executable instructions, when executed, cause the processor 1306 interacting with transceiver 1302 to perform the operations with respect to the wireless network nodes or the IAB nodes (mobile or stationary) described in FIGS. 1-12A.

Those having ordinary skill in the art would understand that the operations or steps of a method described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. Additionally, in some aspects, the operations or steps of a method may reside as one or any combination or set of codes and/or instructions on a non-transitory computer-readable medium, which may be incorporated into a computer program product.

While this disclosure has been described with specific embodiments thereof, it is evident that many alternatives, modifications, and variations may be apparent to those skilled in the art. For example, various components of the embodiments may be interchanged, added, or substituted in other embodiments. Also, all of the elements of each figure are not necessary for the operation of the disclosed embodiments. For example, one of ordinary skill in the art of the disclosed embodiments would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “handover,” “path switch,” and “migration” may be used interchangeably. The terms “includes,” “including,” or any other variations thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, is defined as “including.” Expressions such as “A and/or B” or “at least one of A and B” may include any and all combinations of words enumerated along with the expression. For instance, the expression “A and/or B” or “at least one of A and B” may include A, B, or both A and B. The wording “the first,” “the second” or the like is only used to clearly illustrate the embodiments of the present application, but is not used to limit the substance of the present application.

1. A first base station (BS) for wireless communication, comprising:
at least one memory; and
at least one processor coupled with the at least one memory and configured to cause the first BS to:
configure a cell of a first wireless network node to support an access from or a handover of a mobile wireless network node; and
perform an integration procedure with a first mobile wireless network node via the first wireless network node, wherein at least one cell of the first wireless network node is configured to support an access from or a handover of a mobile wireless network node and the first wireless network node is a parent node of the first mobile wireless network node after the integration procedure.

2. The first BS of claim 1, wherein the first BS comprises a centralized unit (CU) and a distributed unit (DU) coupled to the CU, and wherein the CU is configured to configure a cell of the DU to support an access from or a handover of a mobile wireless network node.

3. The first BS of claim 1, wherein the at least one processor is further configured to:
transmit, to a second BS, first information about whether the cell of the first wireless network node supports an access from or a handover of a mobile wireless network node;
transmit, to the second BS, second information about whether a cell of the DU supports an access from or a handover of a mobile wireless network node;
receive, from the second BS, third information about whether a cell of a second wireless network node supports an access from or a handover of a mobile wireless network node wherein the second wireless network node connects to the second BS; or
receive, from the second BS, fourth information about whether a cell of a DU of the second BS supports an access from or a handover of a mobile wireless network node or not.

4. The first BS of claim 3, wherein the at least one processor is further configured to cause the first BS to transmit, to the first mobile wireless network node, a measurement configuration configuring a measurement with respect to a cell of the second BS, which supports an access from or a handover of a mobile wireless network node, wherein the measurement configuration is based on the third information, the fourth information, or both.

5. The first BS of claim 1, wherein the at least one processor is further configured to cause the first BS to receive a measurement report from the first mobile wireless network node, wherein:
all cells in the measurement report support a handover of a mobile wireless network node; or
for each cell in the measurement report, the measurement report comprises an indication of whether a corresponding cell supports a handover of a mobile wireless network node.

6. The first BS of claim 1, wherein the at least one processor is further configured to cause the first BS to:
transmit, to a second BS, a handover request to hand over the first mobile wireless network node; and
receive, from the second BS, a response to the handover request, wherein the response indicates a handover preparation failure due to a target cell of the handover request not supporting a handover of a mobile wireless network node.

7. The first BS of claim 1, wherein the at least one processor is further configured to cause the first BS to:
transmit, to a second BS, first information about whether a cell of the first BS is a cell of a mobile wireless network node; or
receive, from the second BS, second information about whether a cell of the second BS is a cell of a mobile wireless network node or not.

8. The first BS of claim 7, wherein the at least one processor is further configured to cause the first BS to transmit, to a second wireless network node, a measurement configuration configuring a measurement with respect to a cell of the second BS, which is not a cell of a mobile wireless network node, wherein the measurement configuration is based on the second information.

9. The first BS of claim 1, wherein the at least one processor is further configured to cause the first BS to receive a measurement report from a second wireless network node, wherein:
all the cells in the measurement report are not a cell of a mobile wireless network node; or
for each cell in the measurement report, the measurement report comprises an indication of whether a corresponding cell is a cell of a mobile wireless network node.

10. The first BS of claim 1, wherein the at least one processor is further configured to cause the first BS to:
transmit, to a second BS, a handover request to hand over a second wireless network node; and
receive, from the second BS, a response to the handover request, wherein the response indicates a handover preparation failure due to a target cell of the handover request belonging to a mobile wireless network node.

11. The first BS of claim 1, wherein the at least one processor is further configured to cause the first BS to receive, from a second BS, a first uplink (UL) backhaul adaptation protocol (BAP) configuration associated with a second distributed unit (DU) of a third wireless network node, wherein the third wireless network node comprises a first DU having an F1 connection to the first BS and the second DU having an F1 connection to the second BS.

12. The first BS of claim 11, wherein the at least one processor is further configured to cause the first BS to transmit a second UL BAP configuration associated with the first DU and the second DU to the third wireless network node, and wherein each entry of the second UL BAP configuration indicates whether the corresponding entry is applied to the first DU or the second DU.

13. The first BS of claim 1, wherein the at least one processor is further configured to cause the first BS to transmit a handover request to a second BS to hand over at least one user equipment (UE) served by the first mobile wireless network node, wherein for each of the at least one UE, the handover request indicates at least one of:
whether a corresponding UE is on board of a vehicle mounted by the first mobile wireless network node or surrounds the vehicle mounted by the first mobile wireless network node; or
a handover priority level for the corresponding UE, wherein the handover request is to hand over all connected UEs served by the first mobile wireless network node.

14. A second base station (BS) for wireless communication, comprising:
at least one memory; and
at least one processor coupled with the at least one memory and configured to cause the second BS to:
receive, from a first BS, a first handover request to hand over at least one user equipment (UE) served by a first mobile wireless network node, wherein for each of the at least one UE, the first handover request indicates at least one of:
whether a corresponding UE is on board of a vehicle mounted by the first mobile wireless network node or surrounds the vehicle mounted by the first mobile wireless network node; or
a handover priority level for the corresponding UE, wherein the first handover request is to hand over all connected UEs served by the first mobile wireless network node; and
transmit, to the first BS, a first response to the first handover request.

15. (canceled)

16. A first base station (BS) for wireless communication, comprising:
at least one memory; and
at least one processor coupled with the at least one memory and configured to cause the first BS to:
receive, from a second BS, cell information for a mobile integrated access and backhaul (IAB) network; and
perform a handover procedure for a mobile IAB node from the first BS to the second BS, wherein the mobile IAB node has a radio resource control (RRC) connection to the first BS.

17. The first BS of claim 16, wherein the cell information for the mobile IAB network is contained by a served cell information information element (IE) or a neighbor information IE of an XnAP signaling.

18. The first BS of claim 16, wherein the cell information for the mobile IAB network indicates whether a cell is served by a different mobile IAB node.

19. A method performed by a first base station (BS), comprising:
receiving, from a second BS, cell information for a mobile integrated access and backhaul (IAB) network; and
performing a handover procedure for a mobile IAB node from the first BS to the second BS, wherein the mobile IAB node has a radio resource control (RRC) connection to the first BS.

20. The method of claim 19, wherein the cell information for the mobile IAB network is contained by a served cell information information element (IE) or a neighbor information IE of an XnAP signaling.

21. The method of claim 19, wherein the cell information for the mobile IAB network indicates whether a cell is served by a different mobile IAB node.
